(19) United States
(12) Patent Application Publication
(10) Pub. No.: US 2005/0205473 A1
(43) Pub. Date: Sep. 22, 2005

(54) System and method for sequencing mail in delivery point order

(75) Inventor: Daryl S. Mileaf, Hanover, MD (US)

Correspondence Address: ROTHWELL, FIGG, ERNST & MANBECK, P.C., 1425 K STREET, N.W., SUITE 800, WASHINGTON, DC, 20005, US

(73) Assignee: Northrop Grumman Corporation, Los Angeles, CA (US)

(21) Appl. No.: 10/914,125

(22) Filed: Aug. 10, 2004

Related U.S. Application Data
(63) Continuation-in-part of application No. 10/771,342, filed on Feb. 5, 2004.
(60) Provisional application No. 60/523,113, filed on Nov. 19, 2003.

(51) Int. Cl. B07C 5/00; G06K 9/00

(52) U.S. Cl. 209/584

(57) ABSTRACT

A mail sorting method for sorting mail into delivery point order.

This application is a continuation-in-part of U.S. patent application Ser. No. 10/771,342, filed on Feb. 5, 2004 (status pending), which claims the benefit of U.S. Provisional Patent Application No. 60/523,113, filed on Nov. 19, 2003. The contents of the above identified applications are incorporated herein by this reference.

### BACKGROUND OF THE INVENTION

1. Field of the invention

The present invention relates to systems and methods for sorting mail.

2. Discussion of the Background

The United States Postal Service (USPS) sequences mail in delivery point order in processing centers. The objective of this operation is to remove the need for downstream manual labor to sort the mail pieces into delivery order. This manual process is known as “casing”. That is, as carriers receive their mail for the day, they sort the mail into what is referred to as “delivery point order” or “carrier walk sequence”.

More specifically, casing a set of mail refers to the process of placing each piece of mail in the set into the appropriate cubbyhole in a matrix of cubbyholes. Each cubbyhole in the matrix corresponds to one delivery point on the carrier's route. Thus, by placing each piece of mail into its corresponding cubbyhole and then removing the mail from the cubbyholes in the order in which the carrier traverses his mail route, the carrier can create a bundle of mail that is in carrier walk sequence. Accordingly, the result of the casing operation is that all mail for each address or delivery point in the carrier's route is stacked together in order of delivery point. Thus, when the carrier arrives at a particular delivery point on his/her route, the carrier can simply remove from the “top” of his/her bundle of mail the mail addressed to the particular delivery point.

Because “casing” is a manual process, it can be time consuming and error prone. Casing also represents one of the single largest operating costs for the USPS. Therefore, it is desirable to eliminate this casing operation by providing to the carrier a bundle of all of the mail for the carrier's route in delivery point order.

During the 1990's, the USPS introduced a process for sequencing mail into delivery order. This process is a two-pass sortation process whereby a batch of mail is sorted twice to manipulate the mail pieces into the desired sequence. Specifically, the batch of mail is sorted with an initial pass through the system (i.e., the “first pass”) and then routed back to the system input feeders for second pass processing. In between the first and second pass, the mail is typically stored in a staging system as full trays are created in the system outputs. The need to stage the mail creates the need for a staging system capable of accumulating and organizing large volumes of trays.

Accordingly, a challenge in a two-pass mail sequencing operation is the coordination of staging and feeding of mail during the second pass so that few bottlenecks occur. Because the mail must be processed in a particular order during the second pass, the distribution of mail to the input feeders of the sorting systems can become complex and inefficient as a feeder can spend a large portion of time in an idle state waiting for the proper time to feed the mail in proper sequence.

What is desired, therefore, are systems and methods to overcome these and/or other disadvantages of existing systems.

### SUMMARY OF THE INVENTION

The present invention provides mail sorting systems and methods for sorting mail into delivery point order.

In accordance with one embodiment, the present invention provides a method for sorting mail using a mail sorting machine. The method typically begins with obtaining a bunch of mail comprising a plurality of mail pieces, wherein each of the plurality of mail pieces is addressed to a delivery point on one of R different carrier routes. At some point, at least two sub-sets (e.g., at least a first sub-set and a second sub-set) of the R carrier routes is defined, wherein the first sub-set includes X number of carrier routes, wherein X<R, and the second sub-set includes S number of carrier routes, wherein S+X<=R (in one particular embodiment, S+X=R), and no carrier route that is a member of the second sub-set is a member of the first sub-set.

After obtaining the bunch of mail, the mail is sorted into at least two sets of mail, wherein: (1) the first set of mail comprises N1 batches of mail, (2) the first set of mail corresponds to the first sub-set of carrier routes, (3) the second set of mail comprises N2 batches of mail, and (4) the second set of mail corresponds to the second sub-set of carrier routes.

After sorting the bunch of mail into the at least two sets of mail, the batches from the first set of mail are input into a mail sorting machine in order and sorted into at least X sets of mail, wherein: (1) each one of the X sets corresponds to one carrier route that is a member of the first sub-set of carrier routes, (2) each one of the X sets comprises at least M1 batches of mail, and (3) the mail within each one of said M1 batches of mail is arranged in order (e.g., in delivery point order).

After sorting the first set of mail into the at least X sets of mail, the batches from the second set of mail are input into the mail sorting machine in order and sorted into at least S sets of mail, wherein: (1) each one of the S sets corresponds to one carrier route that is a member of the second sub-set of carrier routes, (2) each one of the S sets comprises at least M2 batches of mail, and (3) the mail within each one of said M2 batches of mail is arranged in order by delivery point.

Advantageously, efficiencies can be gained by processing the first set of mail and then processing the second set of mail after the first set of mail has been processed. Additionally, in several embodiments, (X)(M1)>N1.

The above and other features and advantages of the present invention, as well as the structure and operation of preferred embodiments of the present invention, are described in detail below with reference to the accompanying drawings.

### BRIEF DESCRIPTION OF THE DRAWINGS

The accompanying drawings, which are incorporated herein and form part of the specification, illustrate various embodiments of the present invention and, together with the description, further serve to explain the principles of the invention and to enable a person skilled in the pertinent art to make and use the invention. In the drawings, like reference numbers indicate identical or functionally similar elements. Additionally, the left-most digit(s) of a reference number identifies the drawing in which the reference number first appears.

FIG. 1 is an illustration of a sorting process according to an embodiment of the present invention.

FIG. 2 is a flow chart illustrating the steps of the sorting process.

FIG. 3 is a functional block diagram of an example mail sorting system.

FIG. 4 is a flow chart illustrating a process according to an embodiment of the invention.

FIG. 5 is a table illustrating a first-pass sort plan according to an embodiment of the invention.

FIG. 6 is a table illustrating a first second-pass sort plan according to an embodiment of the invention.

FIG. 7 is a table illustrating a second second-pass sort plan according to an embodiment of the invention.

FIGS. 8A-C illustrate the delivery order sequencing of mail.

### DETAILED DESCRIPTION OF THE PREFERRED EMBODMENT

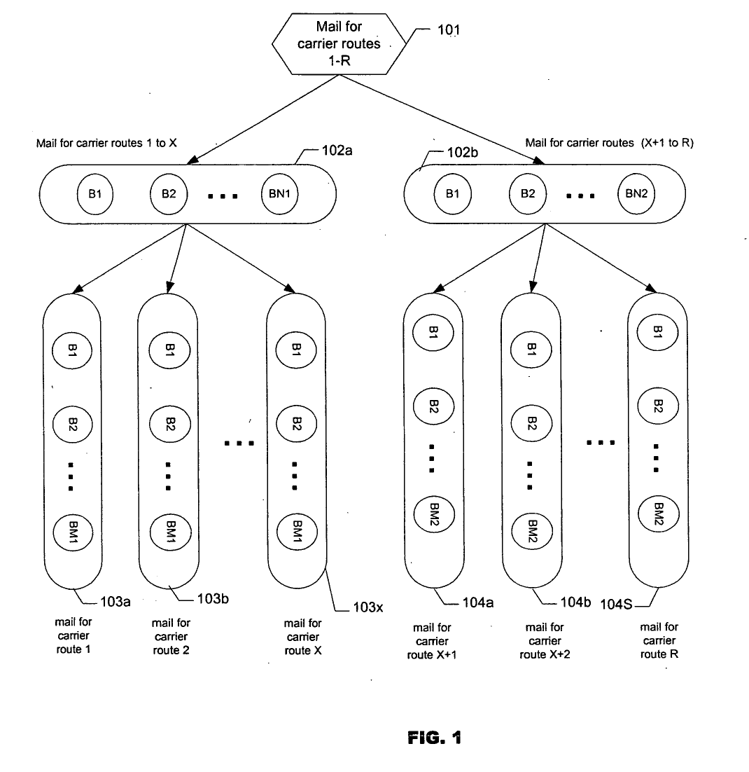

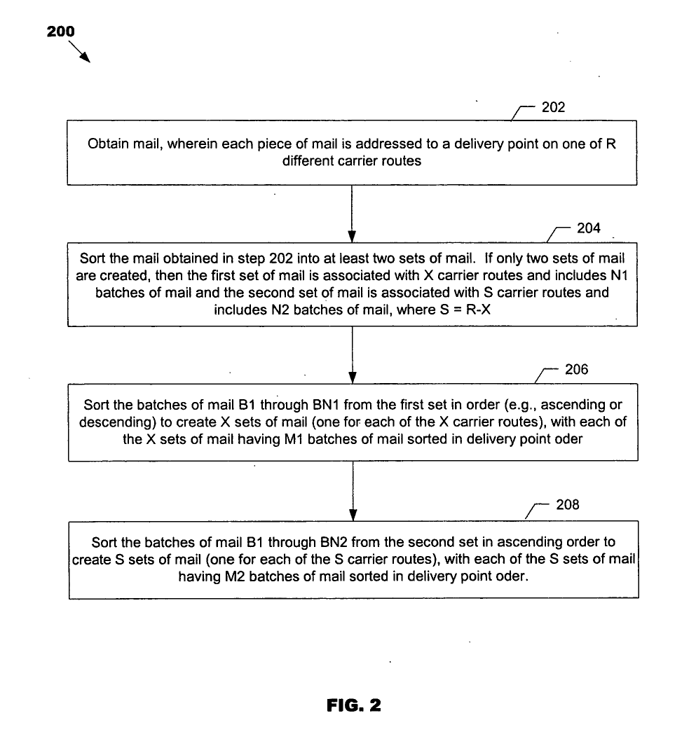

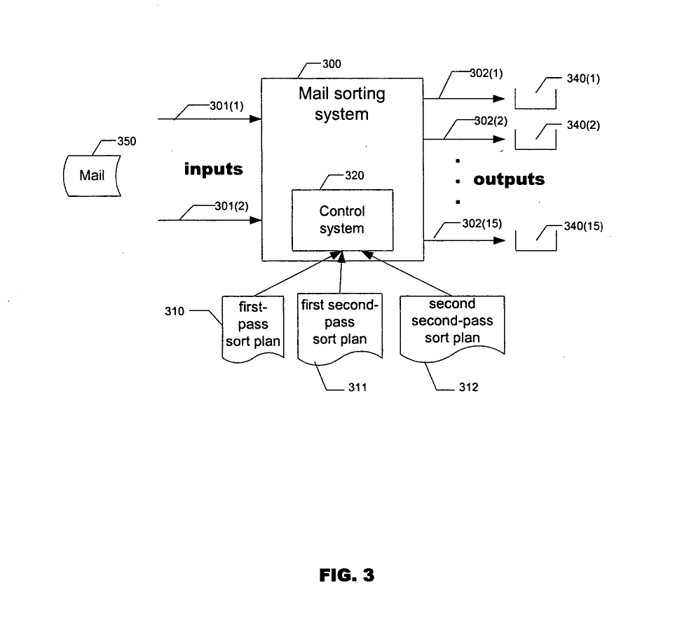

FIG. 1 is an illustration of a mail sorting process according to an embodiment of the present invention and FIG. 2 is a flow chart illustrating the steps of the mail sorting process 200. Process 200 may begin in step 202, where at least one container or batch 101 of mail is obtained. Preferably, each piece of mail in container(s) 101 is addressed to a delivery point on one of R different carrier routes, where R is greater than or equal to 2. For the sake of simplicity we will assume that each carrier route has D delivery points, where D is greater than 1.

In step 204, the mail in container(s) 101 is sorted into at least two sets of mail. Preferably, each set of mail is associated with a non-overlapping set of carrier routes. In this example, for the sake of simplicity, the mail is sorted into two sets, illustrated as set 102a and set 102b. Set 102a includes N1 distinct batches of mail (B1-BN1) and Set 102b includes N2 distinct batches of mail (B1-BN2), as is illustrated in FIG. 1. Additionally, set 102a is associated with carrier routes 1 through X and set 102b is associated with carrier routes X+1 through R. That is, each piece of mail in set 102a is addressed to a delivery point on one of the carrier routes 1 through X, and each piece of mail in set 102b is addressed to a delivery point on one of the carrier routes X+1 through R.

The sorting in step 204 is performed so that batch B_{J} in the first set 102a includes mail addressed only to the following delivery points: RTi-DPk (RTi stands for the ith carrier route), where: i=1,2, . . . , X (X being less than R); and k=J, N1+J, 2*N1+J, . . . , c*N1+J (where c=[ceiling(D/N1)−1] and 1<=J<=N1). Additionally, batch B_{J} in the second set 102b includes mail addressed only to the following delivery points: RTi-DPk, where: i=X+1, X+2, X+3, . . . , R; and k=J N2+J, 2*N2+J, . . . , c*N2+J (where c=[ceiling(D/N2)−1] and 1<=J<=N2).

Thus, for example, if we were to assume that N1=N2=5 and D=15, then the third batch of mail B3 in the first set 102a includes only mail addressed to the following delivery points: RTi-DP3, RTi-DP8, and RTi-DP13, where i=1,2, . . . , X. Similarly, the first batch of mail B1 in the second set 102b includes only mail addressed to the following delivery points: RTj-DP1, RTj-DP6, and RTj-DP11, where j=X+1, X+2, X+3, . . . , R. In one embodiment, D and N1 are fixed and the value of X is chosen such that the following relationship is true: X>N1/ceiling(D/N1). Similarly, in another or the same embodiment, D and N2 are fixed and X and R are chosen so that the following relationship is true: (R−X)>N2/ceiling(D/N2).

In step 206, the mail contained in the batches of mail B1 through BN1 from the first set 102a is sorted. In one embodiment, the batches are sorted in ascending order so that the mail from batch B1 is sorted before the mail from batch B2, the mail from batch B2 is sorted before the mail from batch B3, . . . , and the mail from batch BN1-1 is sorted before the mail from batch BN1. In another embodiment, the batches are sorted in descending order (i.e., starting with batch BN1 and ending with batch 1). In step 206, each batch of mail B_{J} is sorted into at least X sets of mail 103a-x, where each one of the X sets of mail is associated with one carrier route and each one of the X sets of mail includes at least M1 batches of mail (B1-BM1), where M1=ceiling(D/N1), as is illustrated in FIG. 1.

The sorting in step 206 is performed so that after the last batch is sorted (i.e., either batch BN1 or B1) any batch By in any one of the X sets 103 includes mail addressed only to the following delivery points on the route associated with the set: DP[(y−1)*N1+1], DP[(y−1)*N1+2], DP[(y−1)*N1+3, . . . , DPy*N1]. For example, where the second set of mail 103b is associated with carrier route RT2 and assuming N1=5 and D=15, then the third batch B3 in the second set of mail 103b includes mail addressed only to the following delivery points: RT2-DP11, RT2-DP12, RT2-DP13, RT2-DP14 and RT2-DP15.

In step 208, which, preferably, is not performed until after step 206, the batches of mail B1 through BN2 from the second set 102b of mail are sorted in ascending order so that B1 is sorted before B2, B2 is sorted before B3, . . . , and BN2-1 is sorted before BN2. However, as mentioned above, the batches may also be sorted in descending order. In step 208, each batch of mail B_{J} is sorted into at least S sets of mail 104a-s, where S=(R−X) and each one of the S sets of mail is associated with one carrier route and each one of the S sets of mail includes at least M2 batches of mail, where M2=ceiling(D/N2), as is illustrated in FIG. 1.

The sorting in step 208 is performed so that after the last batch is sorted (i.e., either batch BN2 or B1) any batch B_{q} in any one of the S sets 104 includes mail addressed only to the following delivery points on the route associated with the set: DP[(q−1)*N2+1], DP[(q−1)*N2+2], DP[(q−1)*N2+3, . . . , DPq*N2]. For example, where the first set of mail 104a is associated with carrier route RT1 and assuming N2=5 and D=15, then the first batch B1 in set 104a includes mail addressed only to the following delivery points: RT1-DP1, RT1-DP2, RT1-DP3, RT1-DP4 and RT1-DP5.

As is evident from the above description, after performing process 200 the mail in container(s) 101 will be sorted into delivery point order for each of the R routes.

Referring now to FIG. 3, FIG. 3 illustrates a mail sorting system 300 that can be used to carry out the process described above. System 300 includes two input feeders 301(1), 301(2) and fifteen outputs 302(1)-302(15). However, the invention is not limited to this configuration or to any particular mail sorting system or machine. The invention may be able to work with a sorting system having M input feeders (M>0) and N outputs (N>1). For example, it is contemplated that one embodiment has 4 input feeders and at least 360 outputs. Any conventional mail sorting system can be used.

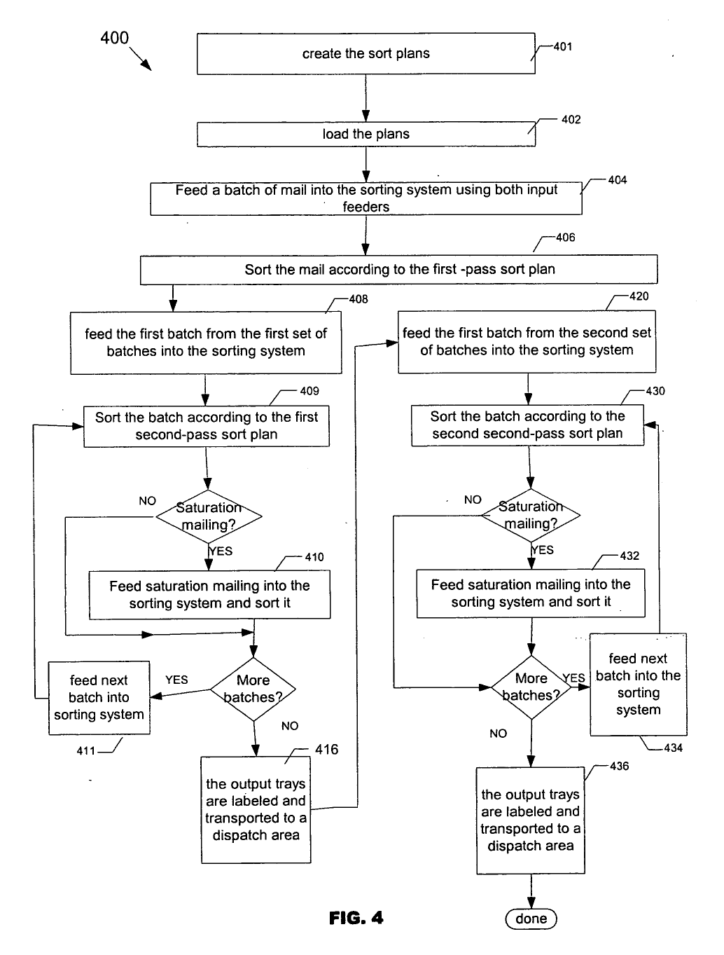

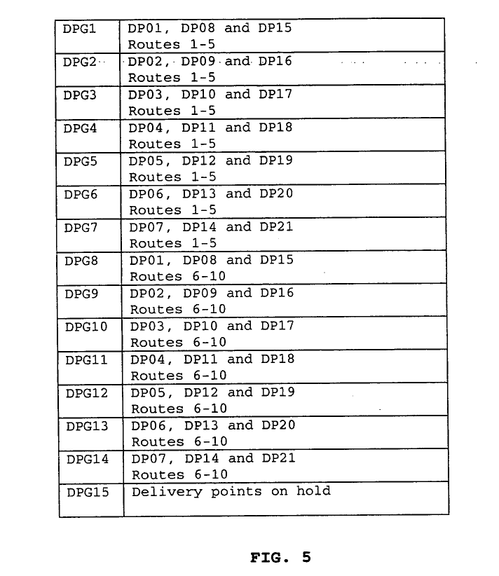

FIG. 4 is a flow chart illustrating a process 400 for sorting mail that uses system 300. In this example, for the sake of simplicity, we shall assume that any given carrier route has only 21 delivery points.

Process 400 begins in step 401, where a first sort plan 310 (a.k.a., the “first-pass” sort plan), a second sort plan 311 (a.k.a., the “first second-pass sort plan”), and a third sort plan 312 (a.k.a., the “second second-pass sort plan”) are created. Although FIG. 3 shows the sort plans 310-312 being separate and distinct, this was done merely for the sake of illustration. For example, in practice, there may be a single master sort plan that contains all of the information specified in plans 310-312 or there may be a single master second-pass sort plan that contains the information contained in plans 311-312. Additionally, there may be multiple second-pass sort plans (i.e., the invention is not limited to any particular number of sort plans).

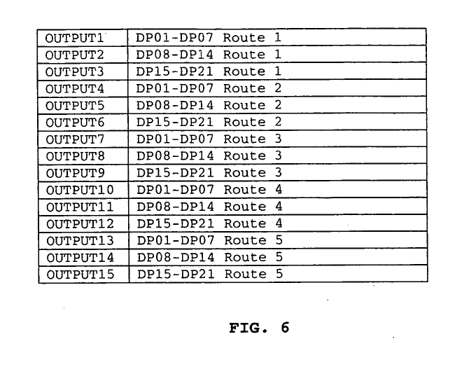

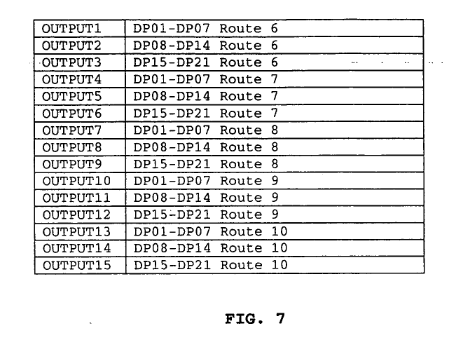

First sort plan 310 specifies at least two sets of some number of delivery point groups. In this example, for the sake of clarity, we will assume that sort plan 310 specifies two sets of seven (7) delivery point groups for a total of fourteen delivery point groups. A delivery point group, as its name implies, is a set of delivery points. FIG. 5 shows the delivery points that are included in each of the fourteen delivery point groups as specified by the first sort plan 310.

As shown in FIG. 5, the set of delivery points (“DPs”) included in a delivery point group J (1<=J<=7) in the first set of delivery point groups is: RTi-DPk, where i=1,2,3,4,5; k=J, N+J, (2)N+J, . . . , (M)N+J; N is the number of delivery point groups in the set (in this case N=7); and M=[ceiling(D/N)−1], where D is the maximum number of delivery points per carrier route, which in this example is 21. Thus, for example, delivery point group 2 (i.e., “DPG2”) includes the following delivery points: RTi-DP2, RTi-DP9, RTi-DP16, where i=1,2,3,4,5.

Similarly, the set of delivery points included in a delivery point group P (8<=P<=14) in the second set of delivery point groups is: RTi-DPk, where i=6,7,8,9,10; k=(P−7), N+(P−7), (2)N+(P−7), . . . , (M)N+(P−7); N is the number of delivery point groups in the set (in this case N=7); and M=[ceiling(D/N)−1], where D is the maximum number of delivery points per carrier route, which in this example is 21. In this example then, M=2. Thus, for example, delivery point group 14 (i.e., “DPG14”) includes the following delivery points: RTi-DP7, RTi-DP14, RTi-DP21, where i=6,7,8,9,10.

The reason we can have five routes represented in each delivery point group is because the maximum number of routes is determined by the following formula: floor((the number outputs available during the second pass)/(the number of wraps created during the first pass)). The number of wraps created during the first pass equals ceiling(D/N) and, in this example, the number of outputs available during the second pass is 15 because system 300 has a total of 15 outputs and all of them will be available. Accordingly, using these numbers the maximum number of routes equals floor(15/ceiling(21/7)), which equals 5.

Advantageously, sort plan 310 may also specify a fifteenth delivery point group (DPG15). In one embodiment, the DPG15 specifies, among other things, a set of delivery points to which mail should not be delivered. For example, if the persons living at delivery point 7 (DP7) on carrier route RT1 are on vacation and they told their local post office to hold their mail while they are away, then DPG15 would include delivery point RT1-DP7 as well as other delivery points to which mail should temporarily (or permanently) not be delivered.

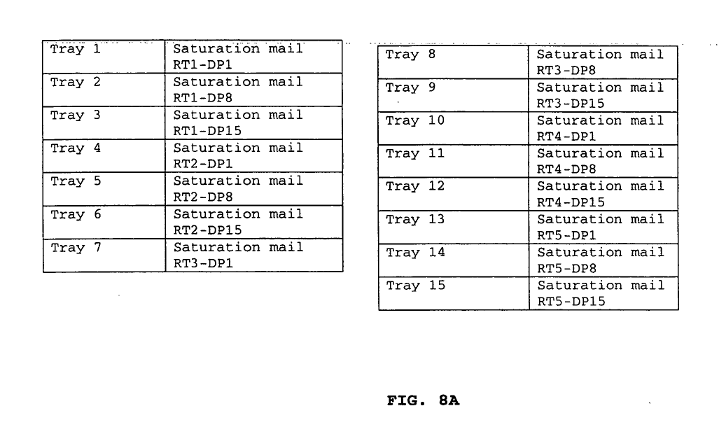

The second sort plan 311 assigns to each one of the 15 outputs a set of delivery points on a route associated with the first set of delivery point groups (i.e., routes 1-5). This is illustrated in FIG. 6. For example, as shown in FIG. 6, DP1 through DP7 on route 1 are assigned to output 1, DP8 through DP14 on route 1 are assigned to output 2, and DP15-DP21 on route 1 are assigned to output 3. Similarly, DP1-DP7, DP8-14 and DP15-DP21 on route 2 are assigned to outputs 4, 5 and 6, respectively.

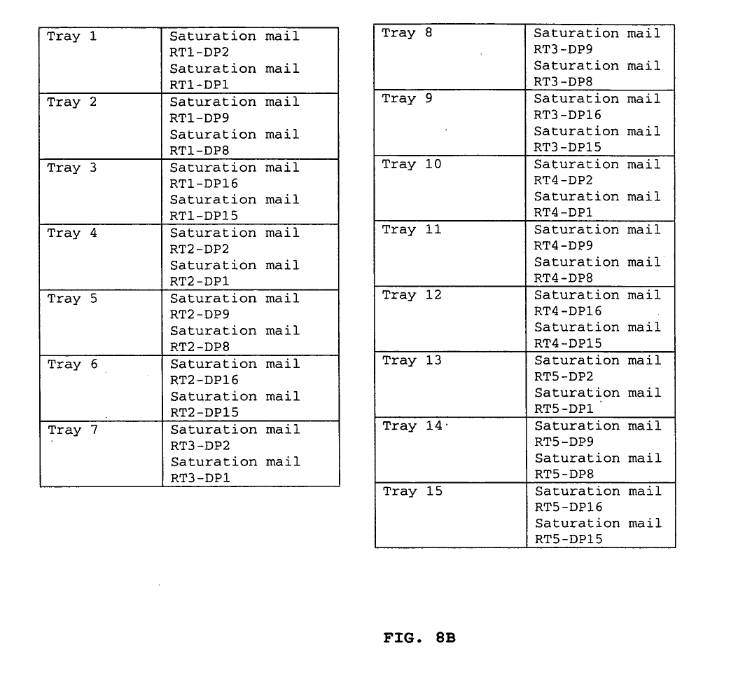

Similarly, the third sort plan 312 assigns to each one of the 15 outputs a set of delivery points on a route associated with the second set of delivery point groups (i.e., routes 6-10). This is illustrated in FIG. 7. For example, as shown in FIG. 7, DP1 through DP7 on route 6 are assigned to output 1, DP8 through DP14 on route 6 are assigned to output 2, and DP15 through DP21 on route 6 are assigned to output 3. Similarly, DP1-DP7, DP8-14 and DP15-DP21 on route 2 are assigned to outputs 4, 5 and 6, respectively.

In step 402, the information specified by sort plans 310, 311 and 312 is loaded into a control system 320 of sorting system 300. In step 404, a batch of mail 350 is fed into system 300 using both input feeders 301(1) and 301(2). Preferably, each piece of mail in the batch is addressed to a delivery point on one of the ten carrier routes RT1 through RT10.

In step 406, controller 320 controls system 300 so that it sorts the batch of mail 350 according to the first sort plan 310. That is, system 300 will sort the batch of mail 350 into 15 batches according to sort plan 310. That is, one batch per each defined delivery point group is created, wherein each batch corresponds to one of the defined delivery point groups.

Accordingly, one of the 15 batches (which we will refer to as “batch-15” or simply “B15”) includes all the mail that should not be delivered (e.g., the mail that is temporarily or permanently on hold). Accordingly, system 300, after receiving a piece of mail, checks to see if the piece of mail is addressed to a delivery point that is included in DPG-15 and, if it is, it adds the piece mail of mail to Batch-15. That is, the piece of mail is added to Batch-15 if it is addressed to a delivery point to which mail should not be delivered.

Each of the other fourteen batches of mail (B1 through B14) created by system 300 and sort plan 310 corresponds to a different one of the delivery point groups (DPGs). For the sake of clarity, we will express this as: batch BN<=>DPGN, which signifies that batch BN corresponds to the Nth delivery point group. Because batch BN corresponds to DPGN, all of the mail that is included in batch BN is addressed to a delivery point that is in DPGN. As a concrete example, every piece of mail that is in batch B1 is addressed to a delivery point that is in DPG1. Referring to FIG. 5, the delivery points that are included in DPG1 are: RTi-DP1, RTi-DP8 and RTi-DP15, where i=1,2,3,4,5; that is the first, eighth and fifteenth delivery points for each of routes 1-5.

Additionally, because each batch corresponds to a delivery point group and because each delivery point group is a member of either the first set of delivery point groups or the second set of delivery point groups, each batch is logically also a member of either a first set of batches, which corresponds to the first set of delivery point groups, or a second set of batches, which corresponds to the second set of delivery point groups. In our example, delivery point groups 1 through 7 (DPG1-DPG7) are all members of the first set of delivery point groups; accordingly batches B1-B7 are all members of the first set of batches. Similarly, delivery point groups 8 through 14 (DPG8-DPG14) are all members of the second set of delivery point groups; accordingly batches B8-B14 are all members of the second set of batches

In one embodiment, system 300 creates the batches B1-B14 by assigning each delivery point on each of the ten routes to one of its fourteen outputs according to the delivery point group to which the delivery point belongs. System 300 does this by assigning each delivery point group to a different one of its fourteen outputs (e.g., DPG1 is assigned to output 302(1); DPG2 is assigned to output 302(2), and DPG14 is assigned to output 302(14)). In this way, after system 300 receives a piece of mail and determines the delivery point to which the mail is addressed, system 300 can automatically route the mail piece to the output 302 to which the delivery point is assigned. As a concrete example, assume that system 300 determined that a particular mail piece is addressed to delivery point RT3-DP16 (the sixteenth delivery point on route 3); in this case the mail piece will be routed to output 302(2) because RT3-DP16 is a member of DPG2 and DPG2 is assigned to output 302(2).

When sorting batch 350 there may be times when an output tray 340 becomes “full.” When an output tray 340 is full no mail should be sent to the output 302 associated with the output tray 340. Consequently, in one embodiment, when system 300 has determined the output to which a particular piece of mail should be routed and has determined that the output tray associated with that output is full, system 300 will buffer or otherwise hold the particular piece of mail until the output tray is no longer full (e.g., the tray at that output has been replaced with a new, empty tray).

Holding mail in the above described manner is not preferable because doing so adversely affects the throughput of system 300. Accordingly, in another embodiment, controller 112 may be configured to dynamically re-assign a delivery point group to an output not currently being utilized when system 300 is ready to route a piece of mail that is addressed to a delivery point in the delivery point group and the system determines that the output to which the delivery point group is assigned is full or otherwise not functioning. Accordingly, the throughput of the system is not adversely affected when an output becomes full, provided that there is an available output to which the delivery point group can be re-assigned.

In step 408, the first batch of mail from the first batch set (i.e., batch B1) is fed into system 300 using one or both input feeders 301. In step 409, controller 112 controls system 300 so that it sorts the batch of mail according to the second sort plan 311. That is, system 300 (1) receives a piece of mail from the batch, (2) analyzes the piece of mail to determine the delivery point to which the piece of mail is addressed and then (3) routes the piece of mail to the output to which the delivery point is assigned. As a specific example, lets assume that system 300 received a piece of mail addressed to delivery point RT5-DP15 (i.e., the fifteenth delivery point on route 5); in this case the piece of mail is routed to output 15 because, as shown in FIG. 6, DP15-RT5 is assigned to output 15. Preferably, one or more trays 340 are positioned at each output to collect the mail routed to the output.

If a saturation mailing exists for any one of the five routes 1 though 5 currently being processed, then step 410 is performed, otherwise the process proceeds to step 414 (assuming there are more batches from the set to process). A saturation mailing for a route is a mailing that covers at least 75% of all delivery points on the route or 90% of the residential delivery points on the route. For example, a local store may wish to send an advertisement to every residential delivery point on one or more routes.

In step 410, at most three pieces of the saturation mailing for each route for which the saturation mailing is intended is fed into system 300, which routes each piece of saturation mail to the appropriate output (the reason that it is at most three pieces per route is because, in our example, each route is associated with at most 3 outputs 302, as shown in FIG. 6, for example). Accordingly, if the saturation mailing is intended for delivery points on three of the five routes, then at most 9 pieces of the mailing are fed into system 300, which routes the at most 9 pieces of mail to the appropriate output. For example, if a saturation mailing is intended for all delivery points on routes RT1 and RT5, then six (6) pieces of the saturation mailing are fed into the system 300 at step 410 and each of the 6 saturation mail pieces will be routed to an output associated with RT1 or RT5. More specifically, in this example, saturation mail pieces are routed to outputs 1, 2 and 3, which are all associated with RT1, and saturation mail pieces are routed to outputs 13, 14 and 15, which are all associated with RT5. Step 410 may be repeated if there is more than one saturation mailing for at least one of the five routes.

In step 411, the next batch in the first set of batches is fed into system 300 (if there is not a next batch, then the process proceeds to step 416). After step 411, control passes back to step 409. In our example, batch B7 is the last batch of the first set of batches. Accordingly, after the last batch is processed, control passes to step 416.

In step 416 (i.e., the end of the second-pass for carrier routes RT1-RT5), the output trays 340 are labeled and transported to a dispatch area where they are staged and prepared for transportation to the appropriate delivery unit while a residual pass (if required) is being performed. After step 416, control passes to step 420.

In step 420, the first batch of the second set (i.e., batch B8) is fed into system 300 using one or both input feeders 301. In step 430, controller 112 controls system 300 so that it sorts the batch of mail according to the third sort plan 312. That is, system 300 (1) receives a piece of mail from the batch, (2) analyzes the piece of mail to determine the delivery point to which the piece of mail is addressed and then (3) routes the piece of mail to the output to which the delivery point is assigned. Preferably, one or more trays 340 are positioned at each output to collect the mail routed to the output.

If a saturation mailing exists for any one of the five routes 6 though 10 currently being processed, then step 432 is performed, otherwise the process proceeds to step 434. In step 432, at most three pieces of the saturation mailing for each route for which the saturation mailing is intended is fed into system 300, which routes each piece of saturation mail to the appropriate output. Step 432 may be repeated if there is more than one saturation mailing for at least one of the five routes.

In step 434, the next batch in the second set of batches is fed into system 300 (if there is not a next batch, then the process proceeds to step 436). After step 434, control passes back to step 430. In our example, batch B14 is the last batch of the second set. Accordingly, after the last batch is processed, control passes to step 436.

In step 436 (i.e., the end of Pass 2 for carrier routes RT6-RT10), the output trays 340 are labeled and transported to a dispatch area where they are staged and prepared for transportation to the appropriate delivery unit while a residual pass (if required) is being performed.

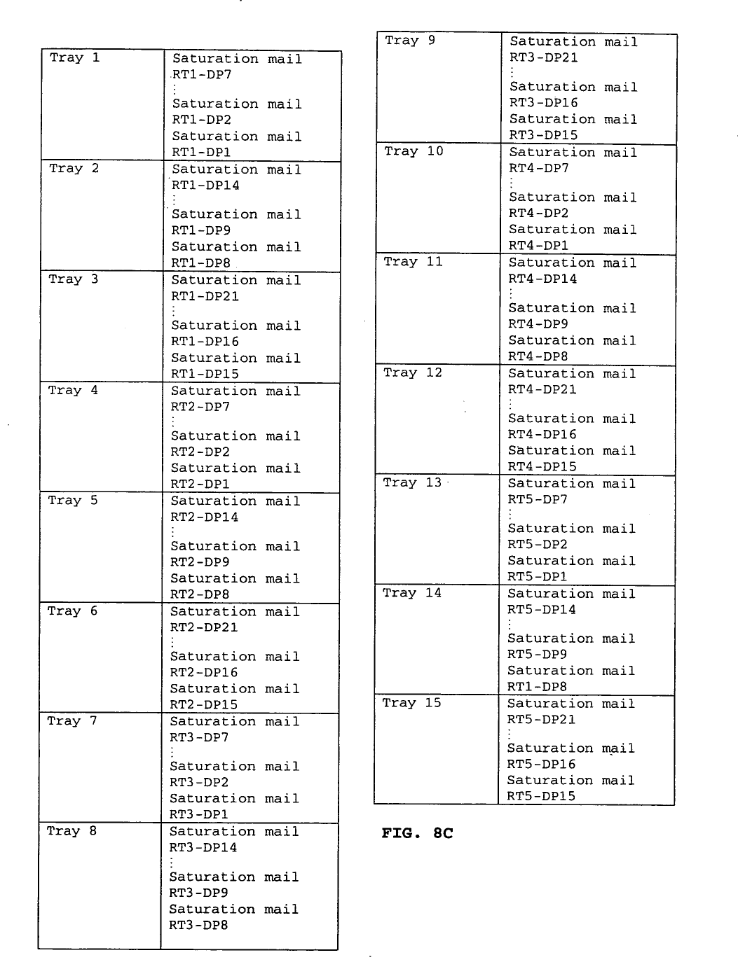

FIG. 8A illustrates the contents of the fourteen trays 340(1)-(14), where each tray 340(X) is positioned to receive the mail routed to output 302(X), after batch B1 and saturation mailings (if any) have been processed (i.e., after the first time steps 408-410 are preformed) (in this example the batches were sorted in ascending order, but, as described above, the batches may also be sorted in descending order). As shown in FIG. 8A, tray 340(1) includes all mail addressed to delivery point RT1-DP1 and zero or more saturation mail pieces, tray 340(2) includes all mail addressed to delivery point RT1-DP8 and zero or more saturation mail pieces, tray 340(3) includes all mail addressed to delivery point RT1-DP15 and zero or more saturation mail pieces, tray 340(4) includes all mail addressed to delivery point RT2-DP1 and zero or more saturation mail pieces, . . . , and tray 340(15) includes all mail addressed to delivery point RT5-DP15 and zero or more saturation mail pieces.

FIG. 8B illustrates the contents of the fourteen trays 340(1)-(14) after batch B2 and saturation mailings (if any) have been processed (i.e., after the second time steps 408-410 are preformed). As shown in FIG. 8B, tray 340(2) further includes all mail addressed to delivery point RT1-DP9 and zero or more additional saturation mail pieces, tray 340(3) further includes all mail addressed to delivery point RT1-DP16 and zero or more additional saturation mail pieces, tray 340(4) further includes all mail addressed to delivery point RT2-DP2 and zero or more additional saturation mail pieces, . . . , and tray 340(15) further includes all mail addressed to delivery point RT5-DP16 and zero or more additional saturation mail pieces.

Finally, as shown in FIG. 8C, after batch B7 and saturation mailings, if any, are processed, tray 340(1) includes all mail addressed to delivery points RT1-DP1 through RT1-DP7 and zero or more saturation mail pieces positioned atop (or underneath) each delivery point; tray 340(2) includes all mail addressed to delivery points RT1-DP8 through RT1-DP14 and zero or more saturation mail pieces; tray 340(3) includes all mail addressed to delivery points RT1-DP15 through RT1-DP21 and zero or more saturation mail pieces; tray 340(4) includes all mail addressed to delivery points RT2-DP1 through RT2-DP7 and zero or more saturation mail pieces; . . . ; and tray 340(15) includes all mail addressed to delivery points RT5-DP15 through RT5-DP21 and zero or more saturation mail pieces.

As shown in FIG. 8C, the present invention sorts routes RT1-RT5 of mail into delivery point order. As illustrated above with respect to FIG. 4, after the mail for routes RT1-RT5 (i.e., the mail in batches B1-B7) are processed, the mail for routes RT6-RT10 (i.e., the mail in batches B6-B10) are similarly processed. Accordingly, after completely performing process 400 all the mail that was in original batch 350 for routes 1-10 is sorted into delivery point order.

One reason it is advantageous to first sort only the mail for routes RT1-RT5 (i.e., batches B1-B7) into delivery point order before sorting the mail for routes RT6-RT10 (i.e., batches B6-B7) into delivery point order is because it minimizes staging requirements and dispatch times, thereby improving the mail sorting process.

While the processes described herein have been illustrated as a series or sequence of steps, the steps need not necessarily be performed in the order described, unless indicated otherwise.

Further, while various embodiments/variations of the present invention have been described above, it should be understood that they have been presented by way of example only, and not limitation. Thus, the breadth and scope of the present invention should not be limited by any of the above-described exemplary embodiments, but should be defined only in accordance with the following claims and their equivalents.

1. A method for sorting mail using a mail sorting machine, comprising:
obtaining a bunch of mail comprising a plurality of mail pieces, each of the plurality of mail pieces being addressed to a delivery point on one of R different carrier routes;
defining a first sub-set of the R carrier routes, wherein the first sub-set includes X number of carrier routes, wherein X<R;
defining a second sub-set of the R carrier routes, wherein the second sub-set includes S number of carrier routes, wherein S+X<=R, and no carrier route that is a member of the second sub-set is a member of the first sub-set;
sorting the bunch of mail into at least two sets of mail, wherein: (1) the first set of mail comprises N1 batches of mail, (2) the first set of mail corresponds to the first sub-set of carrier routes, (3) the second set of mail comprises N2 batches of mail, and (4) the second set of mail corresponds to the second sub-set of carrier routes;
inputting the first set of mail into a mail sorting machine;
sorting the first set of mail into at least X sets of mail, wherein: (1) each one of the X sets corresponds to one carrier route that is a member of the first sub-set of carrier routes, (2) each one of the X sets comprises at least M1 batches of mail, and (3) the mail within each one of said M1 batches of mail is arranged in delivery point order;
after sorting the first set of mail into at least X sets of mail, inputting the second set of mail into the mail sorting machine;
sorting the second set of mail into at least S sets of mail, wherein: (1) each one of the S sets corresponds to one carrier route that is a member of the second sub-set of carrier routes, (2) each one of the S sets comprises at least M2 batches of mail, and (3) the mail within each one of said M2 batches of mail is arranged in delivery point order.

2. The method of claim 1, wherein N1=N2.

3. The method of claim 1, wherein S+X=R.

4. The method of claim 1, wherein (X)(M1)>N1.

5. The method of claim 4, wherein (S)(M2)>N2.

6. The method of claim 5, wherein M1=ceiling(D1/N1), wherein D1 equals the number of delivery points on a route within the first sub-set of routes that has the greatest number of delivery points.

7. The method of claim 6, wherein M2=ceiling(D2/N2), wherein D2 equals the number of delivery points on a route within the second sub-set of routes that has the greatest number of delivery points.

8. The method of claim 7, wherein the mail sorting machine has 0 outputs, wherein 0 is greater than or equal to (X)(M1).

9. The method of claim 7, wherein the mail sorting machine has 0 outputs, wherein 0 is greater than or equal to (S)(M2).

10. The method of claim 7, wherein the mail sorting machine has 0 outputs, wherein 0 is greater than or equal to N1+N2.

11. The method of claim 1, wherein each piece of mail included in the first set of mail is addressed to a delivery point on a carrier route included in the first sub-set of carrier routes.

12. The method of claim 11, wherein each piece of mail included in the second set of mail is addressed to a delivery point on a carrier route included in the second sub-set of carrier routes.

13. A method for sorting a batch of mail into delivery point order using a mail sorting system comprising a first output, a second output, a third output and a fourth output, wherein the batch of mail comprises: mail addressed to delivery points on a first carrier route, mail addressed to delivery points on a second carrier route, mail addressed to delivery points on a third carrier route, and mail addressed to delivery points on a fourth carrier route, the method comprising:
(A) specifying a first-pass sort plan, wherein the first-pass sort plan specifies a first set of delivery point groups and a second set of delivery point groups, wherein (1) the first set of delivery point groups includes a first delivery point group comprising a first and second delivery point on the first carrier route and a first and second delivery point on the second carrier route, and (2) the second set of delivery point groups includes a second delivery point group comprising a first and second delivery point on the third carrier route and a first and second delivery point on the fourth carrier route;
(B) specifying a first second-pass sort plan, wherein the first second-pass sort plan assigns: (1) said first delivery point on said first carrier route to the first output; (2) said second delivery point on said first carrier route to the second output; (3) said first delivery point on said second carrier route to the third output; and (4) said second delivery point on said second carrier route to the fourth output;
(c) specifying a second second-pass sort plan, wherein the second second-pass sort plan assigns: (1) said first delivery point on said third carrier route to the first output; (2) said second delivery point on said third carrier route to the second output; (3) said first delivery point on said fourth carrier route to the third output; and (4) said second delivery point on said fourth carrier route to the fourth output;
(d) feeding the batch of mail into the mail sorting system;
(e) sorting the batch of mail according to the first-pass sort plan to create at least two sets of mail, the first set of mail corresponding to the first set of delivery point groups and the second set of mail corresponding to the second set of delivery point groups, wherein (1) the first set of mail comprises a first batch of mail comprising mail addressed to said first and second delivery points on said first and second carrier routes, and (2) the second set of mail comprises a second batch of mail comprising mail addressed to said first and second delivery points on said third and fourth carrier routes;
(f) feeding the first batch of mail into the mail sorting system and sorting the first batch of mail according to the first second-pass sort plan; and
(g) after sorting all of the batches of mail included in said first set of mail according to the first second-pass sort plan, feeding the second batch of mail into the mail sorting system and sorting the second batch of mail according to the second second-pass sort plan.

14. The method of claim 13, wherein the first set of delivery point groups consists of N1 delivery point groups, and the second set of delivery point groups consists of N2 delivery point groups.

15. The method of claim 14, wherein each delivery point group in the first set of delivery point groups does not include any delivery points from the third or fourth carrier routes, and each delivery point group in the second set of delivery point groups does not include any delivery points from the first or second carrier routes.

16. The method of claim 15, wherein the mail sorting system has not more than 0 outputs, and N1 is less than or equal to 0/2.

17. The method of claim 15, wherein said first set of delivery point groups is associated with X1 carrier routes and said second set of delivery point groups is associated with X2 carrier routes.

18. The method of claim 17, wherein X>N1/(ceiling(D1/N1)), wherein D1 equals the number of delivery points on a route associated with the first set of delivery point groups that has the greatest number of delivery points.

19. A system for sorting a batch of mail into delivery point order, wherein the batch of mail comprises: mail addressed to delivery points on a first carrier route, mail addressed to delivery points on a second carrier route, mail addressed to delivery points on a third carrier route, and mail addressed to delivery points on a fourth carrier route, the system comprising:
a mail sorting machine comprising a first output, a second output, a third output and a fourth output;
a first-pass sort plan, wherein the first-pass sort plan specifies a first set of delivery point groups and a second set of delivery point groups, wherein (1) the first set of delivery point groups includes a first delivery point group comprising a first and second delivery point on the first carrier route and a first and second delivery point on the second carrier route, and (2) the second set of delivery point groups includes a second delivery point group comprising a first and second delivery point on the third carrier route and a first and second delivery point on the fourth carrier route;
a first second-pass sort plan, wherein the first second-pass sort plan assigns: (1) said first delivery point on said first carrier route to the first output; (2) said second delivery point on said first carrier route to the second output; (3) said first delivery point on said second carrier route to the third output; and (4) said second delivery point on said second carrier route to the fourth output;
a second second-pass sort plan, wherein the second second-pass sort plan assigns: (1) said first delivery point on said third carrier route to the first output; (2) said second delivery point on said third carrier route to the second output; (3) said first delivery point on said fourth carrier route to the third output; and (4) said second delivery point on said fourth carrier route to the fourth output; and
inputs for inputting the batch of mail into the mail sorting machine, wherein
the mail sorting machine is configured to sort the batch of mail according to the first-pass sort plan to create at least two sets of mail, the first set of mail corresponding to the first set of delivery point groups and the second set of mail corresponding to the second set of delivery point groups, wherein (1) the first set of mail comprises a first batch of mail comprising mail addressed to said first and second delivery points on said first and second carrier routes, and (2) the second set of mail comprises a second batch of mail comprising mail addressed to said first and second delivery points on said third and fourth carrier routes; and
the mail sorting machine is further configured to (a) sort the first batch of mail according to the first second-pass sort plan and (b) sort the second batch of mail according to the second second-pass sort plan.

20. The system of claim 19, wherein the first set of delivery point groups consists of N1 delivery point groups, and the second set of delivery point groups consists of N2 delivery point groups.

21. The system of claim 20, wherein each delivery point group in the first set of delivery point groups does not include any delivery points from the third or fourth carrier routes, and each delivery point group in the second set of delivery point groups does not include any delivery points from the first or second carrier routes.

22. The system of claim 21, wherein the mail sorting machine has not more than O outputs, and N1 is less than or equal to 0/2.

23. The system of claim 21, wherein said first set of delivery point groups is associated with X1 carrier routes and said second set of delivery point groups is associated with X2 carrier routes.

24. The system of claim 23, wherein X>N1/(ceiling(D1/N1)), wherein D1 equals the number of delivery points on a route associated with the first set of delivery point groups that has the greatest number of delivery points.

25. A method for sorting a batch of mail into delivery point order using a mail sorting system, wherein the batch of mail comprises: mail addressed to a plurality of delivery points on a first carrier route, mail addressed to a plurality of delivery points on a second carrier route, mail addressed to a plurality of delivery points on a third carrier route, and mail addressed to a plurality of delivery points on a fourth carrier route, the method comprising:
(a) inputting the batch of mail into the mail sorting system;
(b) sorting the batch of mail into at least two sets of mail, wherein (1) the first set of mail comprises N1 batches of mail, where N1>1, each of the N1 batches of mail comprising at least one mail piece addressed to a delivery point on the first route and at least one mail piece addressed to a delivery point on the second route, but not containing any mail addressed to a delivery point on either the third or fourth route, and (2) the second set of mail comprises N2 batches of mail, where N2>1, each of the N2 batches of mail comprising at least one mail piece addressed to a delivery point on the third route and at least one-mail piece addressed to a delivery point on the fourth route, but not containing any mail addressed to a delivery point on either the first or second route;
(c) sorting the N1 batches of mail into at least two groups of mail, wherein (1) the first group of mail comprises M1 batches of mail, where M1>1, each of the M1 batches of mail in the first group comprising at least one mail piece addressed to a delivery point on the first route, and (2) the second group of mail also comprises M1 batches of mail, each of the M1 batches of mail in the second group comprising at least one mail piece addressed to a delivery point on the second route; and
(d) after performing step (c), sorting the N2 batches of mail into at least two groups of mail, wherein (1) the first group of mail comprises M2 batches of mail, where M2>1, each of the M2 batches of mail in the first group comprising at least one mail piece addressed to a delivery point on the third route, and (2) the second group of mail also comprises M2 batches of mail, each of the M2 batches of mail in the second group comprising at least one mail piece addressed to a delivery point on the fourth route.

26. The method of claim 25, wherein the mail sorting system has not more than X outputs and N1+N2 is equal or about equal to X.

27. The method of claim 25, wherein neither the first route nor the second route has more than D delivery points and M1=ceiling(D/N1).

28. The method of claim 27, wherein neither the third route nor the fourth route has more than D delivery points and M2=ceiling(D/N2).
